(19) United States
(12) Patent Application Publication
(10) Pub. No.: US 2007/0121628 A1
(43) Pub. Date: May 31, 2007

(54) System and method for source specific multicast

(76) Inventors: James J. Gainer, Keller, TX (US); Edward J. Szczebak JR., Plano, TX (US); Stephen L. Jenkins, Prosper, TX (US); Jack C. Wybenga, Plano, TX (US); Mahlon D. Kimbrough, Sherman, TX (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/291,513

(22) Filed: Nov. 30, 2005

(51) Int. Cl. H04L 12/56

(52) U.S. Cl. 370/390

(57) ABSTRACT

A source specific multicast may be performed in a network, by inspecting a signal for a source specific multicast channel identifier. The source specific multicast identifier signal is then mapped to a frame switching identifier. The frame switching identifier can be mapped to the signal, allowing the signal to be directed a location based on the frame switching identifier.

### BACKGROUND OF THE INVENTION

Prior to growth in the public's demand for data services, such as dial-up Internet access, existing local loop access networks transported mostly voice information. In telephony, a local loop is the wired connection from a telephone company's central office (CO) to its subscribers' telephones at homes and businesses. This connection is usually based on a pair of copper wires called twisted-pair wires. The existing access network typically includes numerous twisted-pair wire connections between a plurality of user locations and a central office switch (or terminal). These connections can be multiplexed in order to more efficiently transport voice calls to and from the central office. The existing access network for the local loop is designed to carry these voice signals, i.e., it is a voice-centric network.

Today, data traffic carried across telephone networks is growing exponentially, and by many measures may have already surpassed traditional voice traffic, due in large measure to an explosive growth of dial-up data connections. The basic problem with transporting data over this voice-centric network, and, in particular, the local loop access part of the network, is that it is optimized for voice traffic, not data. The voice-centric structure of the access network limits an ability to receive and transmit high-speed data signals along with traditional quality voice signals. Simply put, the access part of the existing access network is not well-matched to the type of information it is now primarily transporting. As users demand higher and higher data transmission capabilities, the inefficiencies of the existing access network will cause user demand to shift to other mediums of transport for fulfillment, such as satellite transmission, cable distribution, wireless services, etc.

An alternative existing local access network that is available in some areas is a digital loop carrier (DLC). DLC systems utilize fiber-optic distribution links and remote multiplexing devices to deliver voice and data signals to and from the local users. In a typical DLC system, a fiber optic cable is routed from the central office terminal (COT) to a host digital terminal (HDT) located within a particular neighborhood. Telephone lines from subscriber homes are then routed to circuitry within the HDT, where the telephone voice signals are converted into digital pulse-code modulated (PCM) signals, multiplexed together using a time-slot interchanger (TSI), converted into an equivalent optical signal, and then routed over the fiber optic cable to the central office. Likewise, telephony signals from the central office are multiplexed together, converted into an optical signal for transport over the fiber to the HDT, converted into corresponding electrical signals at the HDT, demultiplexed, and routed to the appropriate subscriber telephone line twisted-pair connection.

Some DLC systems have been expanded to provide so-called Fiber-to-the-Curb (FTTC) systems. In these systems, the fiber optic cable is pushed deeper into the access network by routing fiber from the HDT to a plurality of Optical Network Units (ONUs) that are typically located within 500 feet of a subscriber's location. Multi-media voice, data, and even video from the central office location is transmitted to the HDT. From the HDT, these signals are transported over the fibers to the ONUs, where complex circuitry inside the ONUs demultiplexes the data streams and distributes the voice, data, and video information to the appropriate subscriber.

These prior art DLC and FTTC systems suffer from several disadvantages. First, these systems are costly to implement and maintain due to a need for sophisticated signal processing, multiplexing/demultiplexing, control, management and power circuits located in the HDT and the ONUs. Purchasing, then servicing this equipment over its lifetime has created a large barrier to entry for many local loop service providers. Scalability is also a problem with these systems. Although these systems can be partially designed to scale to future uses, data types, and applications, they are inherently limited by the basic technology underpinning the HDT and the ONUs. Absent a wholesale replacement of the HDT or the ONUs (a very costly proposition), these DLC and FTTC systems have a limited service life due to the design of intermediate electronics in the access loop.

### SUMMARY OF THE INVENTION

A source specific multicast may be performed in a network, by inspecting a signal for a source specific multicast channel identifier. The source specific multicast identifier signal is then mapped to a frame switching identifier. The frame switching identifier can be mapped to the signal, allowing the signal to be directed a location based on the frame switching identifier.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a network including a system in which an embodiment of the present invention may be deployed;

FIG. 2 is a more detailed diagram of network of FIG. 1 including components of a remote digital terminal and an optical networking unit according to an embodiment of the present invention;

FIG. 3 is a detailed block diagram of a host digital terminal and an optical networking unit of FIG. 2 according to an embodiment of the present invention;

FIG. 4 is a detailed block diagram of internal system interfaces of a remote digital terminal and an optical networking unit of FIG. 2 incorporating redundant Ethernet Switch Units according to an embodiment of the present invention;

FIG. 5 is a functional block diagram of an Ethernet Switch Unit of FIGS. 2, 3 and 4.

FIG. 6 is a functional block diagram of a Quad Optical Interface Unit of FIGS. 2, 3 and 4.

FIG. 7 is a functional block diagram of a Broadband Controller of FIGS. 2, 3 and 4.

FIG. 8 is a functional block diagram of a Quad Digital Subscriber Line Card of FIGS. 2, 3 and 4.

FIG. 9 is a signal diagram showing a source specific multicast signal flow, according to principles of the present invention, between an Edge Aggregation Router, various nodes of a remote digital terminal and an optical networking unit, and a subscriber gateway; and

FIG. 10 is a clock to signal timing diagram showing a double data rate transmission, according to principles of the present invention, between a Broadband Controller and a Quad Digital Subscriber Card.

### DETAILED DESCRIPTION OF THE INVENTION

A description of preferred embodiments of the invention follows.

According to principles of the present invention, a system or corresponding method increases available bandwidth for transmission of data, video, and audio to a customer (sometimes curb) within a network. The system includes multiple network nodes. A first network node in the system converts a first optical communications signal to a corresponding first electrical signal with an asynchronous, packet-based format. The first network node processes the first electrical signal in a corresponding, asynchronous, packet-based manner, and routes the first electrical signal to a second network node among a group of secondary network nodes. This second network node converts the first electrical signal to a second optical signal and routes the second optical signal to a third network node among a group of tertiary network nodes. The third network node converts the second optical signal to a corresponding second electrical signal with an asynchronous, packet-based format, processes the second electrical signal in a corresponding, asynchronous, packet-based manner, and routes the second electrical signal to at a fourth network node among a group of quaternary network nodes. This fourth network node transmits the second electrical signal to at least one end user node.

In one embodiment of the invention, a communications system, such as a Digital Subscriber Line Access Multiplexer (DSLAM), or corresponding method increases available bandwidth for transmission of data, video, and audio to a customer premise, or curb node for further distribution to customer premises, within a network. In one embodiment, a system comprises a host digital terminal (HDT) including an Ethernet switch unit and multiple optical interface units coupled via a bus. The optical interface units are configured to communicate over an optical communications link with broadband cards of optical network units (ONUs). The ONUs also include data cards coupled to the broadband cards via a bus. The data cards are configured to communicate over end user communications links to end user nodes.

Some embodiments of the present invention provide network access to higher speed video and data transmissions. An example architecture provides Fiber to the Curb (FTTC) that supports higher bandwidth to the customer premise than a Digital Subscriber Line Access Multiplexer (DSLAM) Host Digital Terminal (HDT) or Central Office solution.

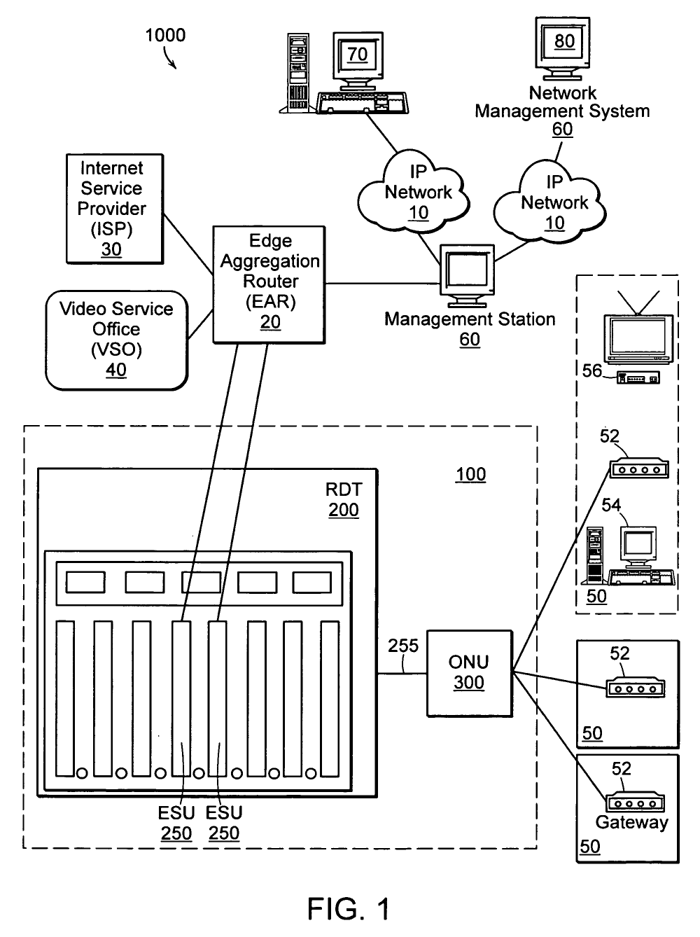

FIG. 1 illustrates an Internet Protocol Television (IPTV) system 100 according to an embodiment of the present invention within a network 1000. The IPTV system 100 may serve as an interface between an end user node, such as a residential gateway 52 and an Edge Aggregation Router (EAR) 20 that may provide voice, video, and/or data services from a media provider.

The EAR 20 may provide access to a Video Service Office (VSO) 40, as well as Internet traffic through an Internet Service Provider (ISP) 30. A management station 60 may operate as an Element Management System (EMS) server to provide low level management and surveillance functions for the system 100. The EMS server 60 may host some or all sessions for a client 70 to access the IPTV system 100. In addition, the EMS server 60 may also communicate with a customer's network management system 80 for service activation, surveillance, and alarm reporting. These communications may be made through a network, such as an Internet Protocol (IP) network 10. The network management system 60 may be an application platform used for managing some or all of the systems in a multi-vendor environment, may provide seamless access to some or all IPTV systems, and may provide some or all flow-through capabilities for service activation and maintenance.

The EMS server 60 may be a custom or commercial server, such as a Sun Solaris® based server application. The EMS client 70 may be an application program and may be loaded onto Microsoft® Windows® or a Sun Solaris® workstation. The client 70 may provide a Graphical User Interface (GUI) front end to the element management system application and may communicate to the EMS server 60. The client 70 allows EMS users to make changes to the IPTV system 100, generate reports, and view status data.

The IPTV system 100 may also interface with an end user node, such as a residential gateway 52, on customer premise(s). In one embodiment, the gateway 52 can provide an interface to customer premises devices 54 for access to the Internet, while also providing an interface to a set top box 56 for providing video services. The IPTV system 100 may provide delivery of voice, video, and data services from a central location to multiple homes.

In the embodiment of FIG. 1, the IPTV system 100 comprises two main components. The first component is a Remote Digital Terminal (RDT) 200 (referred interchangeably with Host Digital Terminal), which provides access points from the router 20. The RDT 200 connects to Optical Networking Unit (ONU) 300 through an optical fiber 255 connection. In a communication system, a single RDT 200 may connect to multiple ONUs through multiple optical fiber connections. The ONU 300 may be located in a local neighborhood to provide the delivery of voice, video, and data services to a number of customer premises 50.

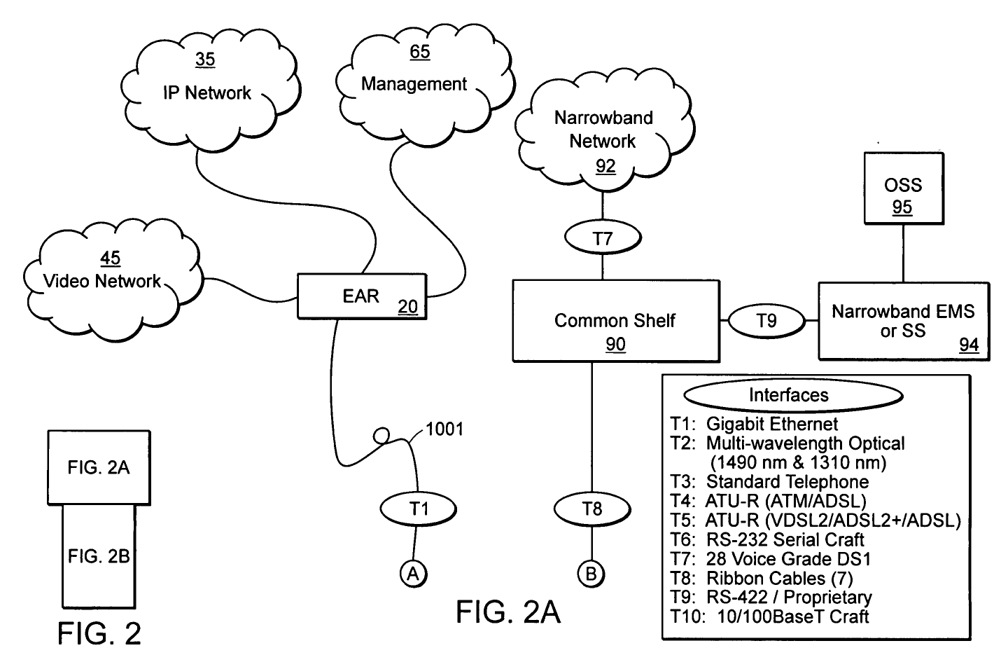

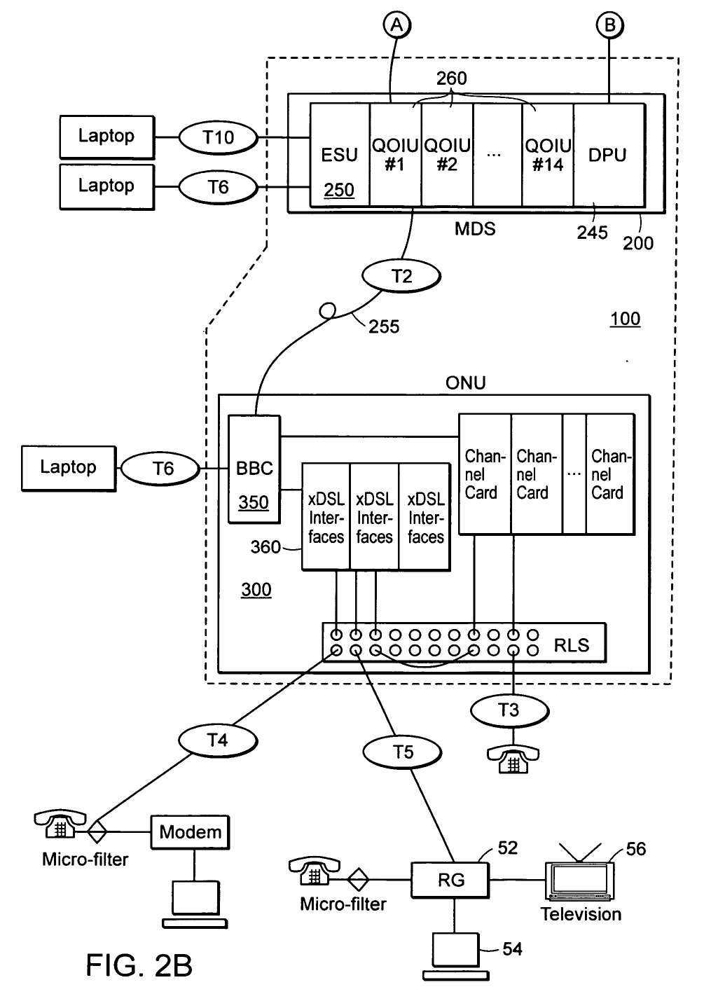

FIG. 2 sets forth a more detailed schematic of the system 1000 shown in FIG. 1. As with FIG. 1, the IPTV system 100 of FIG. 2 has both a Remote Digital Terminal (RDT) 200 and an Optical Network Unit (ONU) 300. Referring to FIG. 2, the RDT 200 may receive incoming signals from the Edge Aggregation Router (EAR) 20 through an optical gigabit Ethernet (GigE) connection 1001 at an Ethernet Switch Unit (ESU) 250 of the RDT 200. The EAR 20 may provide access to a number of Video Service Offices (not shown) through a video network 45, as well as Internet traffic 35. A management station (not shown) may connect to the EAR 20 through a management network 65.

The ESU 250 may be responsible for a first layer of multicast replication within the system 100. The ESU 250 may perform a proxy function for the network elements to track and keep proper multicast channels (not shown) flowing from the EAR 20, through the IPTV System 100, and to the end nodes 52. The RDT 200 may also have a Distribution Processor Unit (DPU) 265. The DPU 265 may provide the RDT 200 with access to a common shelf 90, such as a DISC*S® common shelf, at a Central Office. The common shelf 90 may perform call processing and provide a TR-008 or GR-303 interface to the voice switch. The common shelf 90 may further include a connection to a narrowband network 92 and a narrowband element management system (EMS) 94. The narrowband EMS 94 may provide an interface to the system operator's Operational Support Systems (OSS) 95. The EMS 94 may manage tasks, such as system configuration, provisioning, maintenance, inventory, performance monitoring, and diagnostics.

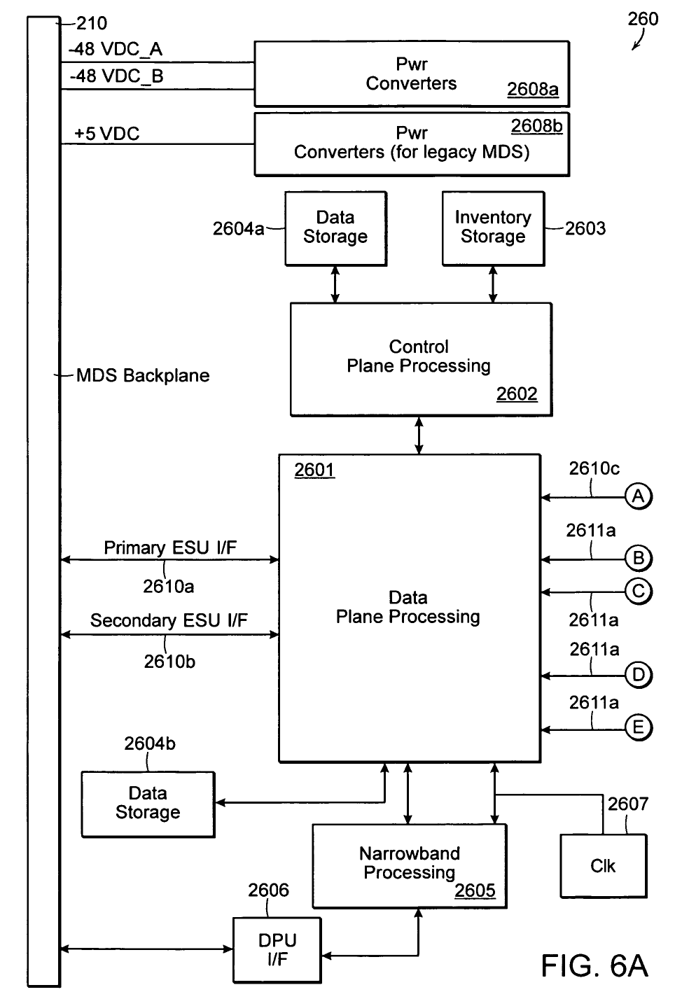

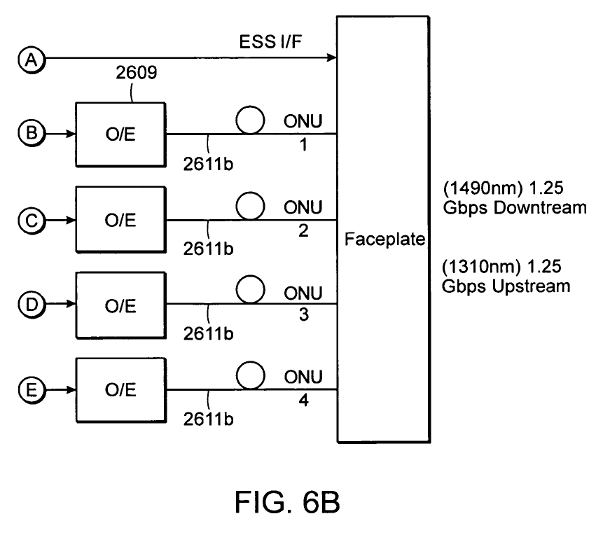

In an embodiment shown in FIG. 2, the ESU 250 connects with fourteen QOIU cards 260 within the RDT 200. Within the system 100, an Ethernet switch (discussed in detail below with respect to FIG. 6) located in the QOIU 260 performs layer 2 functions.

The QDC 360 serves as the interface to the end user node (e.g., residential gateway 52) in a subscriber premises.

In the embodiment of FIG. 2, the BroadBand Controller 350 (BBC) may be responsible for some or all the operations, administration, management, and provisioning functions within the ONU 300. Each BBC 350 may support multiple quad digital subscriber line cards (QDC) 360. The hardware on the BBC 350 is responsible for distributing IP packets or ATM cells to the QDC 360 cards. In addition, the BBC 350 may provide the optical interface (not shown) between the ONU 300 and the QOIU 260.

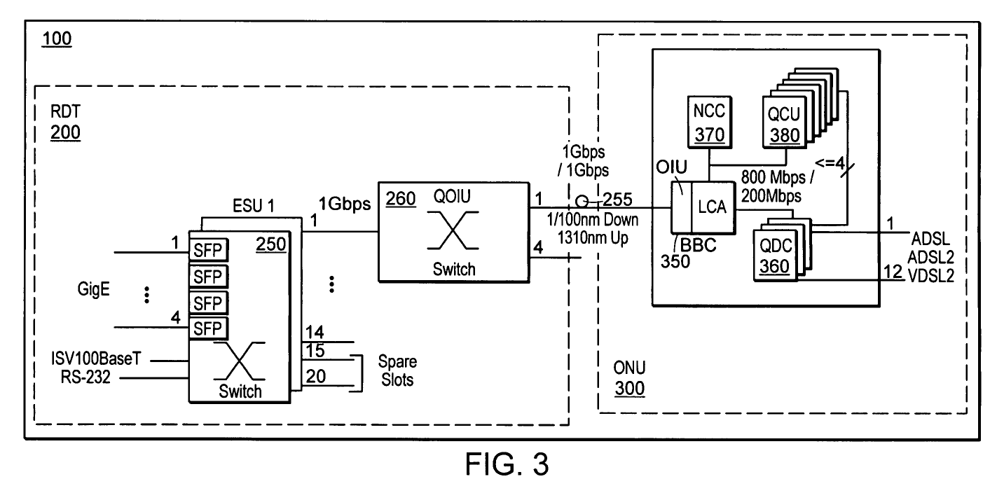

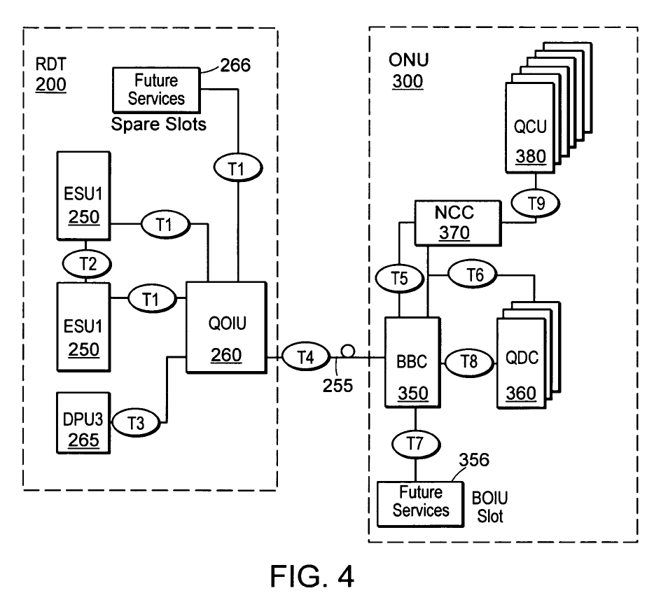

FIGS. 3 and 4 provide a more detailed diagram of embodiments of an IPTV system 100 of both FIGS. 1 and 2.

FIG. 3 illustrates an IPTV system 100 comprising an RDT 200 and an ONU 300. In the embodiment of FIG. 3, within the RDT 200 are at least two primary nodes: at least one Ethernet Switch Unit (ESU) 250 and multiple corresponding Quad Optical Interface Units (QOIU) 260 (only one of which is shown in FIG. 3). The Ethernet Switch Unit (ESU) 250 interfaces with the Quad Optical Interface Units (QOIU) 260 along a backplane (not shown). The ESU 250 may provide an uplink to the EAR 20 of FIGS. 1 and 2, convert optical signals into an electrical signal, and route the electrical signal to an appropriate QOIU 260 using Ethernet Layer 3 information. Each QOIU can subsequently convert electrical signals back into optical signals and transmit the optical signals via optical fiber link(s) to various Optical Network Units 300 (ONU) using Layer 2 information.

In embodiments of the present invention, and as shown in FIG. 4, the RDT 200 may employ two or more ESU 250 units to support a redundancy. As shown in FIG. 4, the ESU 250 connects to the QOIUs 260 in the RDT 200 enclosure. The multiple ESUs 250 may be configured to operate as a single unit, but introduction of redundancy provides additional reliability in the IPTV system 100 shown in FIGS. 1 and 2. Therefore, if one of the ESUs 250 were to fail, the system 100 would lose capacity, but not service. To support this redundancy, the HiGig port from each ESU 250 is cross-connected back to the other ESU 250. Like the QOIU 260 interface, this port is physically connected to the redundant switch module via the RDT 200 backplane (not shown). Multiple ESUs may be combined to form a load sharing redundant unit via a mechanism known as trunk aggregation. Trunk aggregation allows Ethernet links on different ESUs to combine to form a single logical link. When an ESU fails, as indicated by loss of Ethernet link, the connected devices each remove that ESU from its aggregation group.

A link layer is a standardized part of the line level Ethernet protocol which determines the presence of a device on the distant end of an Ethernet link. It is a complex protocol which requires that the line interface be fully functional and, as such, provides a significant level of diagnostic insight into the distant end. The devices at the edge of the switching subsystem each make their own determination vis a vis the viability of the switching subsystem, and, therefore, do not require to communicate or coordinate the redundancy failover event with each other. As such, this mechanism is inherently simpler and more reliable than currently offered reliability strategies, both by its inherent simplicity and its ability to absorb multiple failures.

Consistent with the principles of the present invention, systems may be configured to have only one ESU 250 active at any one time, or they may be configured whereby both ESUs 250 are active. Spare slots at the QOIU 260 may also be provided to adapt the RDT 200 for future services 266.

Continuing to refer to FIG. 3, the ONU 300 also has two primary nodes, at least one BroadBand Controller 350 (BBC) and multiple corresponding Quad Digital Subscriber Line Cards 360 (QDCs). Within the ONU 300, the BBC 350 terminates the RDT interface and splits the narrowband traffic to the Quad Channel Units 380 from the broadband traffic to the QDCs 360. The BBC 350 of FIG. 3 also shows a connection with a narrowband common card 370 (NCC). The BBC 350 receives optical signals from a QOIU 260, converts them into an electrical signal, and switches the electrical signal to the appropriate QDC 260 using (or for narrowband communications, the NCC 370) Layer 2 information.

FIG. 4 also illustrates the DPU 265 and QOIU 260 interface which may transport the narrowband traffic between the RDT and common shelf (shown as 90 in FIG. 2). The narrowband traffic may be transported over a superframe format that may include Pulse Code Modulation (PCM), Channel Unit Data Link (CUDL), ISDN 2 B channels (64 kb/s) and D channels (16 kb/s) Pulse Code Modulation and High Level Data Link Control (HDLC) data for up to twenty-four channels in each of four ONUs 300. This interface may also include the DPU 265 BUS (not shown) that may be used by the DPU 265 to control the QOIU 260 narrowband interface.

The QOIU 260 interfaces with a BroadBand Controller (BBC) 350 at the ONU 300 over an optical connection 255. The ONU 300 may have a spare slot at the BBC 350 that may also be provided to adapt the ONU 300 for future services 356.

In one embodiment, the ESU 250 is responsible for the first layer of multicast replication within the system 100. The ESU 250 may perform an Internet Group Management Protocol (IGMP) proxy function to track and keep all of the proper multicast channels flowing from the Edge Aggregation Router 20 (EAR).

Elements within the RDT 200 and ONU 300, such as the ESU 250, QOIU 260, BBC 350, and QDC 360, may be referred to as “nodes” or “network nodes.” Through use of these nodes, some embodiments of the present invention may be employed. It should be understood that the nodes may be physically separated from each other.

With reference to FIGS. 2, 3, and 4, the optical link 255 between the QOIU 260 and BBC 350 may have a 1.25 Gbps symmetrical interface rate. The interface rate may allow the QOIU 260 switch to be connected to the BBC 350 switch without additional glue logic. The BBC 350 converts an optical signal (not shown) through a line card aggregator function. Optical circuitry may be provided on a printed circuit board (not shown) in the BBC 350.

The BBC 350 processor may be responsible for some or all of the DSP management functions in the ONU 300. The BBC 350 may support ADSL, ADSL2+, VDSL2 and Quad DS1 line cards.

FIG. 4 shows internal data interfaces between the various components of the IPTV system according to an embodiment of the present invention. A QOIU 260 in the RDT 200 may connect to an ESU 250 gigabit port. In embodiments of the present invention, this interface may comply with the IEEE 802.3 standard. The physical connection between the modules may be via an interface across the RDT 200 backplane (not shown). In embodiments of the present invention, the SerDes signals connect the Ethernet switch devices on the ESU 250 to the QOIU 260 without the need for external glue logic. The transmission between the two points employs 8B/10B encoding.

The interface between the QOIU 260 and the BBC 350 provides the link between the RDT 200 and the ONU 300. This interface is an optical connection 255. In embodiments of the present invention, this optical connection uses a 1490 nm wavelength for downstream transfers and 1310 nm for upstream transfers. In such an embodiment, the raw bit rates for this interface may be 1.25 Gbps downstream and 1.25 Gbps upstream. This connection may support a distance of 12,000 feet between the RDT 200 and ONU 300.

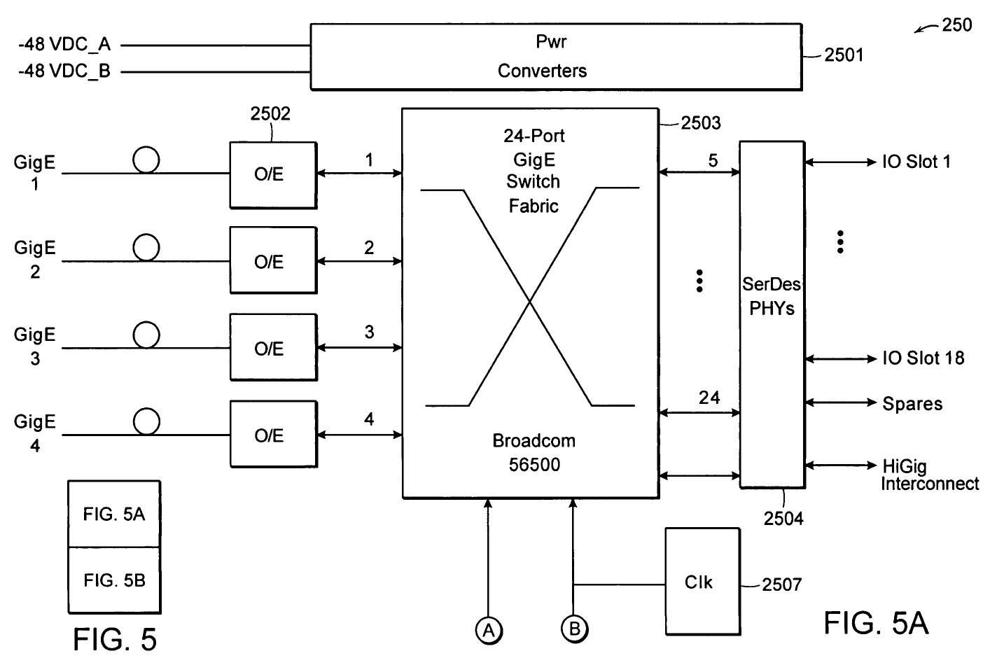

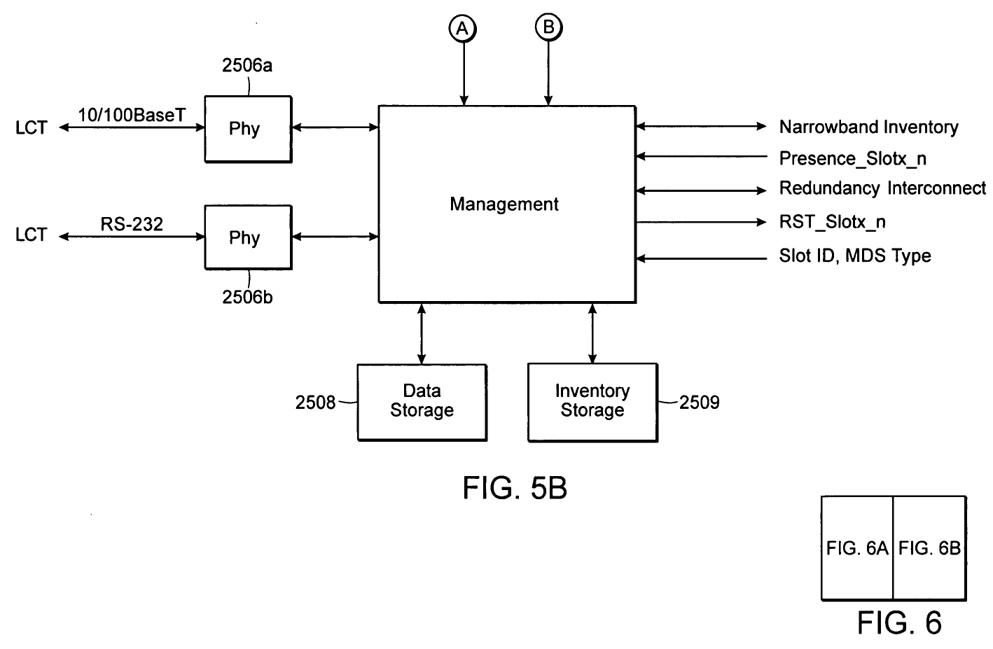

As shown in FIG. 5, in one embodiment of the present invention, the ESU 250 is a 24-Port GigE Layer ⅔Ethernet switch 2503, such as a Broadcom® BCM56500 24-Port Gigabit Ethernet Multilayer Switch by Broadcom Corporation of Irvine, Calif. In this embodiment, the ESU 250 supports four Small Form-factor Pluggable (SFP) gigabit uplink ports 2502 for optical-to-electrical conversion, and twenty gigabit SerDes interfaces 2504 to its backplane I/O (not shown).

The switch 2503 shown in FIG. 5 connects to a management module 2505 which may support a 10/100BT port 2506a and a serial port 2506b for craft. The management module 2505 may also interface with a data storage unit 2508 and an inventory storage unit 2509. A clock 2507 provides timing for both the switch 2503 and the management module 2505. The ESU 250 of FIG. 5 also has a power converter 2501 that interfaces with the backplane (not shown). The ESU 250 may operate primarily as a Layer 2 Ethernet switch for unicast traffic, but may also have significant Layer 3 capabilities in hardware for multicast traffic.

The RDT 200 may also house one or more Quad Optical Interface Units (QOIU) 260. Each QOIU 260 may connect with an ESU 250 through GigE SerDes links to a backplane (not shown) or through Small Form-factor Pluggable (SFP) ports. The QOIU 260 is specifically designed to support the IPTV architecture with the hardware capability to maintain narrowband (i.e., voice channels) interfaces (shown below with respect to FIG. 6) in existing systems.

In an embodiment of the present invention, as shown in FIG. 6, the QOIU may be equipped with a 12-port Layer 2/3 Ethernet switch 2601, such as either a Broadcom® BCM5695 or the BCM5696 12-Port Gigabit Ethernet Multilayer Switch. In FIG. 6, the Ethernet switch 2601 performs layer 2 functions. Signals 2610a and 2610b are exchanged between the switch 2601 and both a primary and secondary ESU over a backplane 210. The switch 2601 may also have an interface with a control plane processing module 2602, which in turn interfaces with a data storage unit 2604a and an inventory storage unit 2603. The switch 2601 may also directly interface with a data storage unit 2604b. The switch 2601 may interface with a narrowband processing module 2605, which connects to the backplane 210 through a distribution processing unit 2606.

A clock 2607 may provide timing for both the switch 2601 and the narrowband processing module 2605. In this embodiment, electrical signals 2611a transmit directly with the switch 2601 and four Small Form-factor Pluggable (SFP) gigabit uplink ports 2609 for optical-to-electrical conversion, providing optical connections 2611b with downstream ONUs (not shown in FIG. 6). The switch 2601 may have a port for an Ethernet Aggregation Switch (EAS) interface that provides an additional link for signals 2610c in an upgrade configuration. The QOIU 260 of FIG. 6 also has two power converters 2608a and 2608b that interface with the backplane 210.

Each QOIU 260 may also serve as an interface to a broadband controller (BBC) 350 at one or more ONU devices 300 over a multi-wavelength optical connection. In the embodiment shown in FIG. 6, each optical interface of the QOIU 260 provides a bidirectional, symmetrical, 1.25 Gbps link using a 1490 nm wavelength in the downstream path and a 1310 nm wavelength in the upstream path.

In addition to broadband data traffic, this interface between the QOIU and the BBC transports narrowband payload and maintenance information encapsulated in IP Packets. This interface is symmetrical in that the same types of packets are transmitted in both the downstream path as well as the upstream path. In the downstream path, the narrowband payload is received by the QOIU 260 from the DPU 2606 as in FIG. 6. The QOIU collects the narrowband traffic and forms the payload in a narrowband processing module 2605, and the payload is encapsulated in an Ethernet packet. In the upstream direction, the QOIU switches all narrowband packets to the narrowband processing function 2605. The payload is extracted and sent to the DPU 2606.

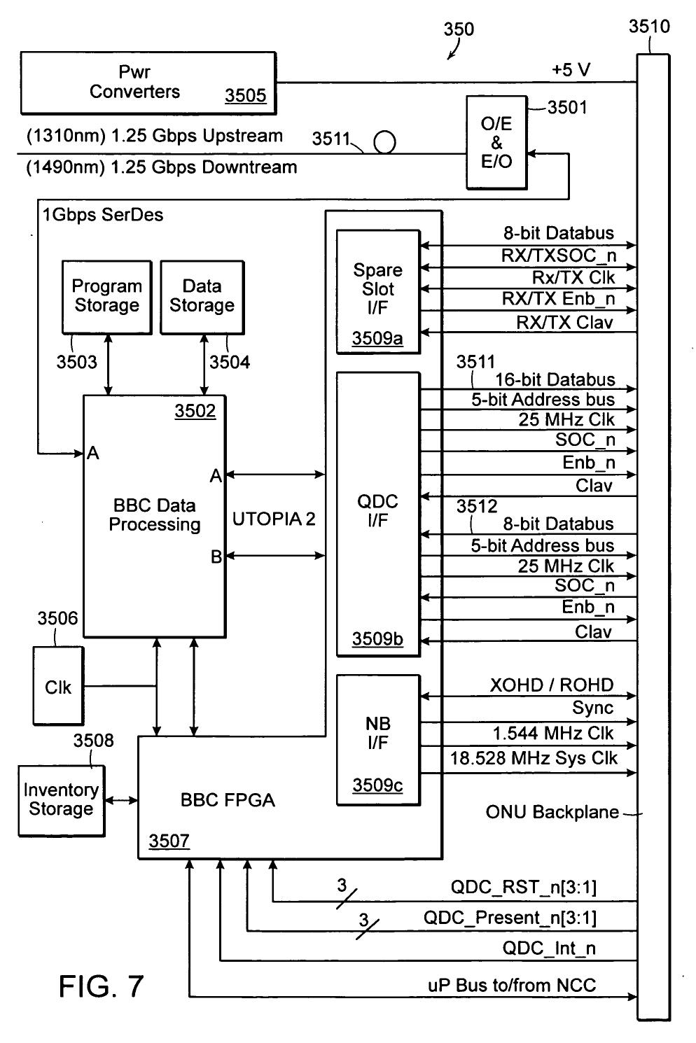

FIG. 7 is an embodiment of a BBC in accordance with an embodiment of the present invention. With reference to FIG. 7, the BBC 350 includes a Line Card Aggregator (LCA) 3502, such as the Broadcom® BCM6550A. An optical-to-electrical converter 3501 interfaces with the DSP 3502 to provide an optical connection 3511 with an upstream QOIUs (not shown in FIG. 6.). The LCA 3502 may also have a program storage module 3503 and a data storage module 3504. The BBC 350 may also have a power converter 3505 that interfaces with the backplane 3510.

The BBC 350 may use a Field Programmable Gate Array (FPGA) 3507 that interfaces with the LCA 3502 and a backplane 3510. In such an embodiment, the FPGA implements some of the functions on the BBC that cannot be handled by the LCA DSP, such as: Medium Access Control (MAC) address translation between provisioned network MACs and learned subscriber MACs; VLAN ID translation as cell or PTM traffic passes through the device; UTOPIA 2 conversion to/from the ONU backplane UTOPIA architecture; and termination of the narrowband traffic and conversion from the fiber format to that required by the NCC backplane interface and narrowband line cards. A narrowband interface module 3509c is shown on the FPGA 3507. The FPGA 3507 also has a QDC interface module 3509b and a spare interface 3509a. A clock 3506 provides timing for both the DSP 3502 and the FPGA 3507. The FPGA 3507 also interfaces with an inventory storage module 3508.

As shown in FIG. 7, signals from the FPGA 3507 are exchanged with the QDC (not shown in FIG. 7) over an asymmetrical UTOPIA-like backplane interface 3510. UTOPIA describes a Universal Test & Operations Physical Interface for ATM level 1 data path interface, as defined in technical specifications by the ATM Forum. UTOPIA describes the interface between the Physical Layer and upper layer modules, such as the ATM Layer, and various management entities. The UTOPIA bus is the standard interface between asynchronous transfer mode (ATM) link and physical layer devices. It covers rates from sub-100 Mbit/s to 155 Mbit/s and gives guidance for 622 Mbit/s. 8-bit wide data paths use octet-level/cell-level handshake at 25 MHz. UTOPIA Level 2 is an addendum to Level 1 and describes support of a data rate of 622 Mbit/s over a 16-bit wide data path at 33 and 50 MHz.

The interface to the QDC 360 is a point-to-multipoint interface. In an embodiment according the principles of the present invention, the downstream transfers are accomplished on a double-data rate 16-bit bus 3511 while the upstream is an 8-bit UTOPIA bus 3512. The transfer clock rate for both the downstream and upstream data transfers is 25 MHz.

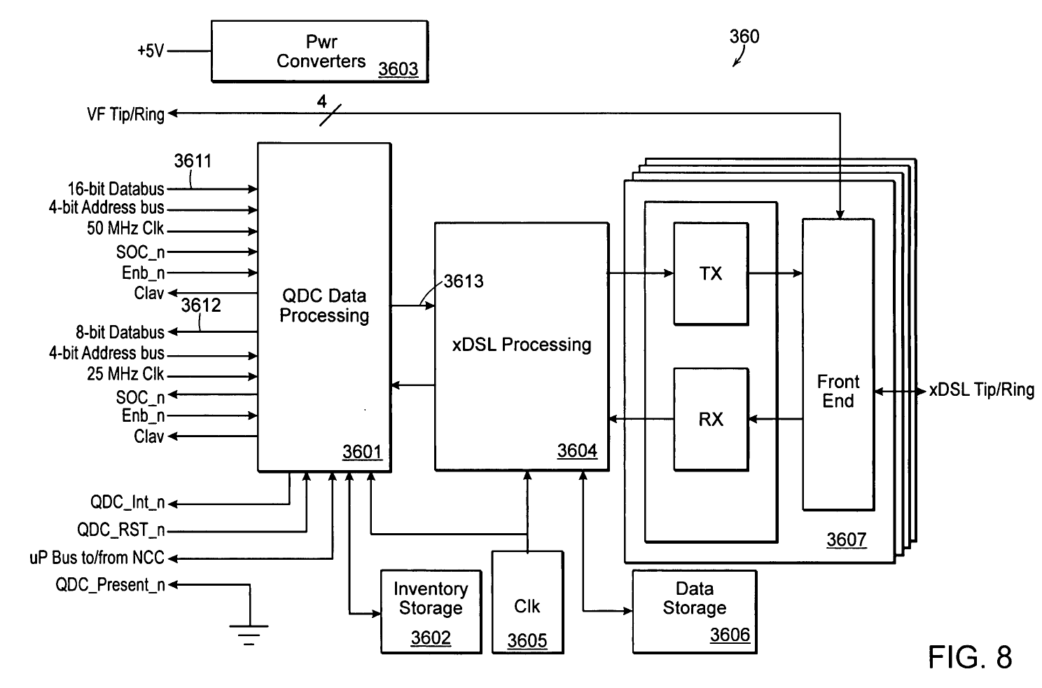

The Quad Digital Subscriber Line Card (QDC) 360 is a subscriber line card in the ONU. This card may support four ports of ADSL/ADSL2+ or VDSL2 service. As shown in FIG. 8, a QDC 360 may consist of a FPGA 3601 that provides the glue logic functions needed to support the interface between the BBC 350 switch and a QDC 360 DSP 3604. A DSP used in a QDC in accordance with the present invention may be the Broadcom® BCM6510. The FPGA 3601 handles the ATM operations, administration and management functions, as well as the downstream bus 3611 translation from 16 bits double data rate to the DSP's 8-bit single data rate bus 3613. A QDC 360 is capable of supporting the various XDSL modes of service (e.g. ADSL, ADSL2, ADSL2+, VDSL2 and T1.413). In an embodiment according to the principles of the invention shown in FIG. 8, the card may support four ports of ADSL/ADSL2+ or VDSL service. In embodiments of the present invention, the FPGA may also interface with an inventory storage module 3602. A clock 3605 provides timing between the FPGA 3601 and the DSP 3604. The DSP 3604 may also interface with a data storage module 3606.

In addition to the DSP 3604, the QDC 360 may also comprise analog front ends (AFEs) 3607, line drivers (not shown) and low-pass filters (not shown) for DSL service. As an example, an AFE used in a QDC in accordance with the present invention may be the Broadcom® BCM6505. Management of the QDC 360 is performed in-band by the BBC 350.

In one embodiment, due to the limitations of existing hardware in ONU backplanes, the interface between the BBC 350 and a QDC 360 is a 16-bit UTOPIA 2 downstream bus 3611 operating at approximately 25 MHZ for all control timing and double data rate for all data bus timing. The QDC 360 may also have a power converter 3603 that interfaces with the backplane (not shown).

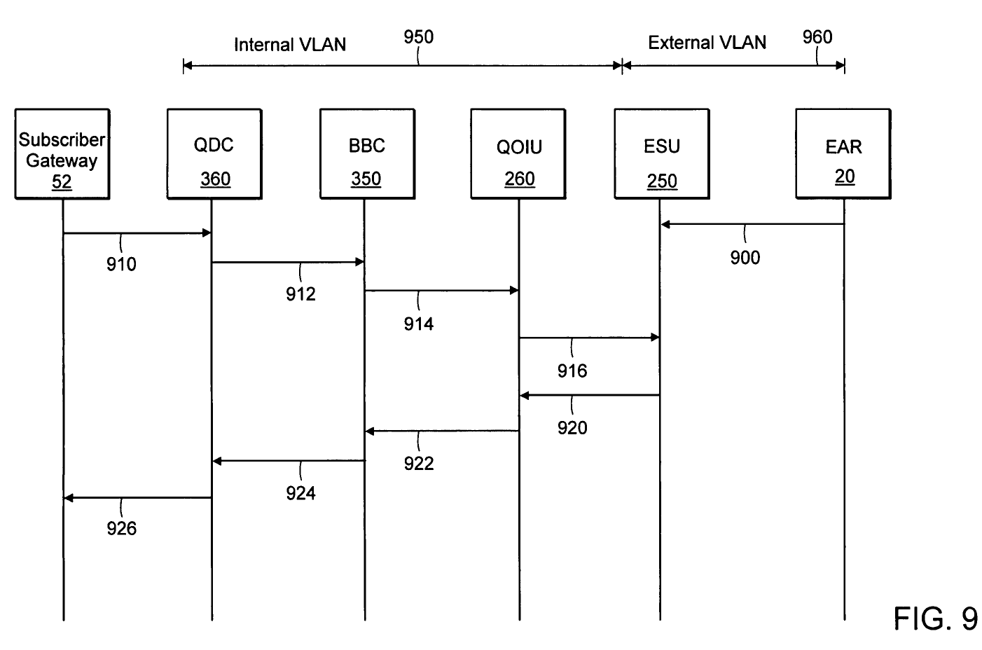

The IPTV system 100 of an embodiment of the present invention as described above allows a service provider to provide a source specific multicast of a signal. According to principles of the present invention, a source specific multicast may be performed in a network, by inspecting a signal for a source specific multicast channel identifier. The source specific multicast identifier signal is then mapped to a frame switching identifier. The frame switching identifier can be mapped to the signal, allowing the signal to be directed a location based on the frame switching identifier. FIG. 9 is a high level diagram that shows the signal flow for an exemplary source specific multicast according to an embodiment of the present invention.

A subscriber gateway device 52 makes a request to “Join” a particular multicast channel. This “Join” request 910 includes the Media Access Control (MAC) address of the specific device 52, as well as the request for the specific channel. This request 910 travels upstream through the IPTV system. The signal first arrives at the QDC 360, where the signal 912 is forwarded to the BBC 350. From the BBC 350, the signal 914 is forwarded to the QOIU 260. At the QOIU, the signal 916 is forwarded to the ESU 250.

At the ESU 250, an Edge Aggregator Router (EAR) 20 may feed a source specific multicast signal 900 to the ESU 250. The ESU 250 inspects the signal 916 for a source specific multicast channel identifier. The ESU 250 then maps the multicast signal 900 to a frame switching identifier, such as an Ethernet frame, and then applies the frame switching identifier to the signal 916. Once the signal is mapped, the multicast signal 900 may be switched back to the subscriber gateway 52 through the various port assignments through a switching stream 920, 922, 924, and 926. At the subscriber gateway 52, the frame switching identifier of the received signal 926 may be translated to a different identifier for processing. This different identifier may include the original source specific multicast channel identifier, including an Internet Protocol (IP) address, or some unique predefined channel identifier. The source specific multicast channel identifier may be mapped using a destination address, or a destination address and some combination of a source address or VLAN address.

The signal flow allows for the inspection of a multicast signal 900 with Ethernet Layer 3 information to be mapped to Layer 2 frames for delivery through a switching stream 920, 922, 924, and 926. In some instances, intermediary nodes, such as the QDC 360, the BBC 350, or the QOIU, may already be aware of a particular VLAN assignment made to the requested channel 910, and may assign the switching port, accordingly.

In an embodiment of the present invention, the system provides a Layer 2 MAC bridge between the network 100 and the subscriber 52, with a VLAN 950 separation of traffic (e.g., different Virtual Local Area Networks (VLANs) may be used for different Internet Service Providers (ISPs)). In one embodiment, there is no bridging provided between subscribers. This may be referred to as “forced forwarding” from the subscriber to the network. Further, the system may provide replication of multicast streams from the network to subscribers based on subscriber Internet Group Management Protocol (IGMP) requests. At any point in the system, multicast signals can be replicated and directed to a number of different nodes within a different downstream switching stream (alternative switching streams not shown).

Data traffic on the network side may fall within various VLANs. These VLANs may include:
Management VLAN—may contain management traffic from an element management system.
IPTV VLAN—may contain the IPTV source specific multicast streams
IPTV Internet VLAN—may contain traffic to the internet for IPTV subscribers in a separate VLAN from the multicast video traffic.
Legacy VLAN—may carry traffic from legacy subscribers with ADSL Internet and no IPTV.
Other ISP VLANs—may carry traffic from other third-party ISPs
Point to Point VLAN—may provide a Point-to-Point service as a VLAN per port.

In accordance with certain embodiments of the present invention, the subscriber interface to the IPTV system may be an ADSL, ADSL2+ or VDSL interface. The primary protocol stack may be (i) Ethernet over ATM in AAL5 for ADSL and (ii) Ethernet over EFM for VDSL. Specific layers above the primary protocol stack depend on the type of subscriber and network device(s) to which the subscriber is connected. In an Ethernet system, traffic may be bridged before it can reach a Broadband Remote Access Server function.

A simple VLAN implementation may involve a Transparent LAN service (TLS). The implementation is a standard Ethernet switch in which a network VLAN is added at the subscriber port. If the subscriber port contains a VLAN, the network VLAN is stacked on top of the subscriber VLAN. Within the access network (e.g., Matrix (MX) or Fiber-in-the-Loop (FITL)), the BBC's DSP (shown in FIG. 7) in the ONU may be configured as a network VLAN endpoint. Ethernet traffic may be passed with no filtering. Virtual MACs may not be allowed in this configuration. If the subscriber connection is ATM, there may be multiple Permanent Virtual Circuits (PVCs) on the connection, and each PVC may be mapped to a separate network VLAN. Some embodiments do not allow for multiple PVCs to be mapped to the same VLAN. Internal routing to the PVC may be based on the VLAN ID only. This VLAN configuration is sometimes referred to as 1:1 or port-based VLANs.

In embodiments of the present invention, legacy ATM Internet subscribers may use a similar implementation as Transparent LAN services (TLS) with some exceptions. With legacy ATM, only one PVC is used. Further, in such embodiments, all network traffic may be Point to Point Protocol over Ethernet (PPPoE). This means it may be possible to apply a filter to allow only PPPoE traffic. This VLAN configuration is N:1, meaning that multiple subscribers map to the same network VLAN, and routing to a port is based on VLAN and MAC. Finally, with a Legacy ATM service, it may be possible to configure Virtual MACs (i.e., up to eight), if desired.

In connection with an embodiment of the present invention, IPTV subscribers can have two paths to the network. One path is for Internet (ISP) traffic, and the second path for the video network. In this configuration, the IPTV system performs some additional routing beyond a standard Ethernet switch. In particular, the IPTV system may separate the Video and ISP traffic into two separate network VLANs. Network to subscriber routing may be standard. Both VLANs may be merged to a single port. In one embodiment, multicast traffic and Internet Group Multicast Protocol (IGMP) queries are routed from the video VLAN to the subscriber. There may be no unicast traffic on the video network in some networks. The subscriber-to-network routing may be more complicated. The following operation occurs at the subscriber edge. Depending on the service, the IPTV system according to some embodiments of the present invention either (i) translate VLAN identifiers or (ii) insert on subscriber ingress and remove on subscriber egress. When inserting a tag, the priority may also be specified. The translation values or insertion values may be provisioned on a per circuit (port or ATM VC) basis.

In embodiments according to the present invention, MAC address translation may be provided on the subscriber ports. The addresses to use for translation may be assigned as a block to the IPTV system. The simplest implementation is to assign a block equal to the number of ports times eight and to use a fixed mapping per port. MAC address translation provides certain the benefits, such as prevention of certain attacks (e.g., MAC routing table spoiling, impersonation, etc.). Protection may also be provided from duplicate MAC addresses with different customers (e.g., due to manufacturer errors or user misconfiguration). Other embodiments may be use for IP address assignment and additional security in the network (e.g., MAC address identifies the port).

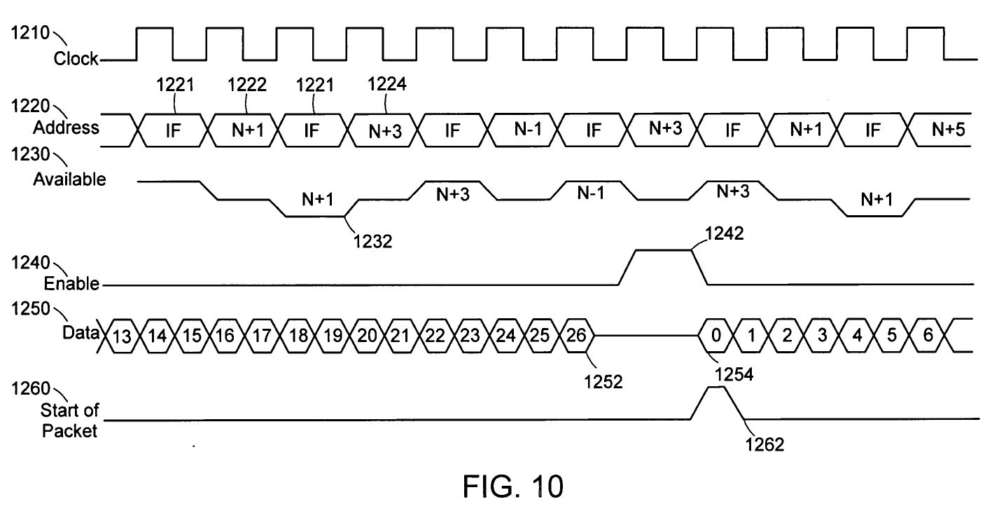

Although the BBC/QDC interface is a UTOPIA level 2-like interface, the clock-to-data and control signal timing relationship may be modified to increase performance of the interface. In particular, data may be transmitted at a “double data rate” between the BBC 350 and QDCs 360 at the ONU 300 in order to improve system bandwidth. According to principles of the present invention, data is transmitted between a first node, e.g. a BBC 350, and at least one second node, e.g. a QDC 360 of an optical networking unit. Data transmission begins at the first node, which polls at least one second node for availability of a data transfer. The polling occurs at a first rate, typically based on a rise and a fall of a clock cycle generated from the first node. Once the first node receives a signal indicating a second node's availability to receive data, the first node sends an initiating signal to the second node and begins transferring data to the at least one available address at twice the first rate used for the polling. The overall interface signal, timing is specified in FIG. 10.

FIG. 10 shows a signal timing between a BBC 350 (not shown in FIG. 10) and a QDC 360 (not shown in FIG. 10). A clock signal 1210 provides synchronization between the BBC 350 and the QDC 360, and a given rate may be based on the rising and falling edges of the clock cycle for which a data transfer may be associated. In one embodiment, the BBC 350 continually transmits a polling signal 1220 at every other clock cycle to the QDCs 360 for availability of a data transfer, sending a source address 1222, 1224. In-between polling transmissions, the BBC 350 transmits an idle signal 1221. The BBC 350 may have any number of signal source addresses to send in a polling signal. The BBC 350 may select to transmit any one of those source addresses based on various types of networking algorithms. For example, the BBC 350 may select the signal source address sequentially, using a priority queue method or a round robin method.

In one embodiment, a QDC 360 communicates with the BBC by providing a signal that indicates availability 1230. When the QDC is available to receive a data transmission from an available address, the transmission signal 1230 indicates availability to receive a particular address 1232. As shown in FIG. 10, the BBC 350 continues to send polling requests 1220 while it is transmitting data 1250. Once the BBC 350 completes a transmission 1252, having previously received an availability signal 1232 from a QDC 360, the BBC sends a transmission initiation signal 1242 to the particular QDC 360. Subsequently, the BBC may simultaneously send a “start of cell” (or alternatively “start of packet”) signal 1260 along with a transferring data 1254 to the at least one available address at twice the first rate. By receiving the initiation signal 1242, the QDC 360 knows that the subsequent data transmission from the BBC 250 occurs at a double data rate.

It should be apparent to those of ordinary skill in the art that methods involved in the present invention may be embodied in a computer program product that includes a computer usable medium. For example, such a computer usable medium may consist of a read-only memory device, such as a CD-ROM disk or convention ROM devices, or a random access memory, such as a hard drive device or a computer diskette, having a computer readable program code stored thereon.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of performing source specific multicast, the method comprising:
inspecting a signal for a source specific multicast channel identifier;
mapping the source specific multicast channel identifier to a frame switching identifier;
applying the frame switching identifier to the signal; and
directing the signal to a location based on the frame switching identifier.

2. A method of claim 1 further comprising:
after directing the signal to the location, translating the frame switching identifier to a different identifier.

3. A method of claim 2 wherein the different identifier is the original source specific multicast channel identifier.

4. A method of claim 3 wherein the different identifier is a different predefined identifier.

5. A method of claim 1 wherein the source specific multicast identifier is an Internet Protocol (IP) identifier.

6. A method of claim 5 wherein the source specific multicast identifier comprises a destination address.

7. A method of claim 5 wherein the source specific multicast identifier comprises a destination address and a source address.

8. A method of claim 5 wherein the source specific multicast identifier comprises a destination address and a VLAN address.

9. A method of claim 5 wherein the source specific multicast identifier comprises a destination address, a source address, and a VLAN address.

10. A method of claim 5 wherein the source specific multicast identifier comprises a destination address and a source address.

11. A method of claim 1 further comprising replicating a signal based on the switching identifier.

12. A method of claim 11 further comprising directing the replicated signals to multiple locations as specified by the switching identifier.

13. A method of claim 1 wherein the frame switching identifier is transported on an Ethernet frame.

14. A method of claim 13 wherein directing the signal occurs based on an Ethernet layer 2 protocol.

15. A system for performing source specific multicast, the system comprising:
an inspection unit configured to inspect a signal for a source specific multicast channel identifier;
a mapping unit configured to map the source specific multicast channel identifier to a frame switching identifier;
a processor configured to apply the frame switching identifier to the signal and directing the signal to a location based on the frame switching identifier.

16. A system of claim 15 wherein the processor is a first processor and the location comprises a second processor configured to receive the signal from the first processor and to translate the frame switching identifier of the signal to a different identifier.

17. A system of claim 16 wherein the different identifier is the original, source specific, multicast channel identifier.

18. A system of claim 17 wherein the different identifier is a different predefined identifier.

19. A system of claim 15 wherein the source specific multicast identifier is an Internet Protocol (IP) identifier.

20. A system of claim 19 wherein the source specific multicast identifier comprises a destination address.

21. A system of claim 19 wherein the source specific multicast identifier comprises a destination address and a source address.

22. A system of claim 19 wherein the source specific multicast identifier comprises a destination address and a VLAN address.

23. A system of claim 19 wherein the source specific multicast identifier comprises a destination address, a source address, and a VLAN address.

24. A system of claim 19 wherein the source specific multicast identifier comprises a destination address and a source address.

25. A system of claim 15 further comprising:
an intermediary processor configured to replicate the signal into multiple replicated signals based on the frame switching identifier.

26. A system of claim 25 wherein the intermediary processor is further configured to direct the replicated signals to multiple locations as specified by the frame switching identifier.

27. A system of claim 15 wherein the frame switching identifier transported on an Ethernet frame.

28. A system of claim 27 wherein the processor directs the signal to the location based on an Ethernet layer 2 protocol.
